(19) United States
(12) Patent Application Publication
(10) Pub. No.: US 2022/0292372 A1
(43) Pub. Date: Sep. 15, 2022

(54) METHODS AND SYSTEMS FOR PROCESSING APPROVAL REQUESTS USING PRE-AUTHORIZED APPROVAL INFORMATION IN AN APPLICATION-INDEPENDENT PROCESSING SYSTEM

(71) Applicant: Capital One Services, LLC, McLean, VA (US)

(72) Inventors: Rendheer JOSHY, McLean, VA (US); William DONEGAN, McLean, VA (US); Shashi PARUPATI, McLean, VA (US); Joseph LUPINO, McLean, VA (US); Craig HOFFERBERT, McLean, VA (US); Melanie WEYER, McLean, VA (US); Stephen MORT, McLean, VA (US); Tamika HARRIS-SMITH, McLean, VA (US); Yelena SHERMAN, McLean, VA (US)

(73) Assignee: Capital One Services, LLC, McLean, VA (US)

(21) Appl. No.: 17/197,960

(22) Filed: Mar. 10, 2021

(51) Int. Cl. G06N 5/04; G06N 20/00; G06F 16/11

(52) U.S. Cl. CPC G06N 5/04; G06N 20/00; G06F 16/122

(57) ABSTRACT

Methods and systems are described herein for processing approval requests using application-independent processing system. The processing system provides a configuration file that may be used to define a process. Each application, or each process in an application, may define its own process parameters in the configuration file. The use of this architecture allows for the processing system to be used with multiple applications. When an approval request is received, the processing system obtains the configuration file of the process to which the approval request corresponds and executes the process accordingly. The processing system also facilitates automatic approval of an approval request using pre-authorized approval information that is provided by an approver independent of the approval request. If an approval request satisfies conditions defined in the pre-authorized approval information, the approval request is automatically approved without user intervention.

### TECHNICAL FIELD

The invention relates to processing approval requests using an application-independent processing system and using pre-authorized approval information to automatically approve the requests without the need of an approver manually approving the requests upon receipt of the requests.

### BACKGROUND

In recent years, applications are increasingly using processing approval processes for processing product or service requests from users. However, current processing systems are typically application specific, that is, the processing systems may not be used across applications, and even if some processing systems may be used across applications, configuring them for different applications is cumbersome.

### SUMMARY

Methods and systems are described herein for an improved computer architecture in networked computer systems that uses an application-independent processing system for processing approval requests from an application. For example, applications are increasingly using approval processes for processing product or service requests from users. Conventional processing systems, however, are tightly integrated to the applications. For example, an approval request from one application transverses a completely different process routine than approval requests from another application. For example, to process a leave request from an employee of an organization, a processing system may have to be implemented for the leave request application, and to process a product request such as a request for a laptop by the employee, another processing system may have to be implemented for the product request application. Since the processing systems are specific to the application, not only the time and effort in implementing or maintaining the processing systems is duplicated, significant amount of computing resources that otherwise may be minimized are consumed and a failure of anyone program may have system-wide effects such as system errors and crashes. Notably, even if some of the conventional processing systems are configurable to be used across applications, which are based on the application-specific nature of the processes is unlikely, configuring them is time consuming and complicated and even more prone to system errors and crashes as the application-specific processing systems must now interface with each other.

Accordingly, methods and systems are described herein for processing approval requests using an application-independent processing system. The processing system provides a configuration file that may be used to define a process. For example, the configuration file may include process parameters such as number of approval levels required to approve a request, information regarding approvers in each approval level (e.g., name, e-mail, mobile phone number or other such information) or a function to determine the approvers in the approval levels, information regarding content to be included in an approval notification to an approver, or other such parameters. Each application, or each process in an application, may define its own process parameters in the configuration file. When an approval request is received, the processing system obtains the configuration file of the process to which the approval request corresponds and executes the process accordingly. For example, when an approval request for a product is received from a user of a product request application, the processing system may obtain the configuration file implemented by the product request application, obtain the information regarding approvers authorized to approve the request from the configuration file and send approval notifications (e.g., via email, text or other notification) to the approvers. Upon receiving the response from the approvers, the processing system may update the status of the approval request (e.g., approved, rejected, pending or other status information) and send a notification to the user accordingly. Similar approval process may be performed for approval requests for other applications.

With respect to automatic approval of approval requests, conventional processing systems typically require a user (e.g., an approver) to approve the approval requests. Accordingly, conventional processing systems may not support automatic approvals, that is, approving the approval request without any user intervention from the approvers upon receipt of the approval request, which may be a drawback. For example, the conventional processing system may receive multiple approval requests in a specified period and an approver may not be available to approve the requests, or even if the approver is available, manually reviewing and approving the requests may become unsustainable as the number of approval requests increase, thereby causing delays in the approvals, which may affect users adversely. Some processing systems may support approving the approval requests automatically but may not do so based on approver-defined conditions for automatic approvals, thereby wrongly approving or rejecting the requests in some cases. The conventional processing systems may not be capable of interpreting the data in the approval requests and therefore, may not be capable of automatically approving the approval based on a result of whether the content of the approval requests satisfy the approver defined conditions. As the number of applications using processes for approving requests increases, the use of conventional processing system becomes untenable because the systems may not be capable of analyzing the content of various approval requests and determine whether to automatically approve or reject the requests, or even if they are approved or rejected, the accuracy of such rejections or approval may be less than expected.

Accordingly, to overcome these technical problems with respect to conventional processing systems, methods and systems are described herein for an improved processing architecture in networked computer systems. In particular, the methods and systems include a new function routine that automatically approves an approval request based on pre-authorized approval information provided by an approver. The processing system facilitates an approver to provide pre-authorized approval information that may be used for automatically approving an approval request received in the future. The pre-authorized approval information may include conditions for automatically approving the approval requests. For example, the approver may specify parameters that an approval request may have to satisfy for the approval request to be automatically approved. The parameters may include user related parameters (e.g., username, user ID, user designation in an organization, or other such user parameters), product/service-related parameters (e.g., product/service name, configuration, type, etc.), date or period the approval request has to be received, or other such parameters that approval request may have to satisfy for being automatically approved without any user intervention from the approver upon receipt of the approval request.

Additionally, the methods and systems may use a machine learning model in determining a likelihood of approval of an approval request by an approver. The likelihood may be represented as a score and this score may be used in determining whether to automatically approve or reject the approval request. The machine learning model is trained using data related to a number of approval requests approved or rejected by an approver to generate the score. The machine learning model may also predict a sentiment of the approver in approving or rejecting an approval request. Typically, a prediction of positive sentiment may be indicative of an approval of the approval request and a prediction of negative sentiment may be indicative of a rejection of the approval request by the approver. The predictions related to the score or sentiment may be provided as context to an approver to assist the approver in making a decision to approve or reject the approval request. The score or sentiment may also be used as additional data in determining whether to automatically approve or reject an approval request, thereby improving an accuracy of automatic approvals.

Various other aspects, features, and advantages of the invention will be apparent through the detailed description of the invention and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 shows a system for facilitating approval of an approval request using an application-independent processing system, in accordance with one or more embodiments.

FIG. 2 shows a machine learning model configured to facilitate prediction of an approval or approver sentiment, in accordance with one or more embodiments.

FIG. 3 is shows and example configuration file and pre-authorization approval information, in accordance with one or more embodiments.

FIG. 4 shows a flowchart of a method for processing an approval request using an application-independent processing system, in accordance with one or more embodiments.

FIG. 5A shows a flowchart of a method for processing an approval request to obtain approver response, in accordance with one or more embodiments.

FIG. 5B shows a flowchart of a method for automatically approving an approval request based on pre-authorized approval information, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art, that the embodiments of the invention may be practiced without these specific details or with an equivalent arrangement. In other cases, well-known structures and devices are shown in block diagram form to avoid unnecessarily obscuring the embodiments of the invention.

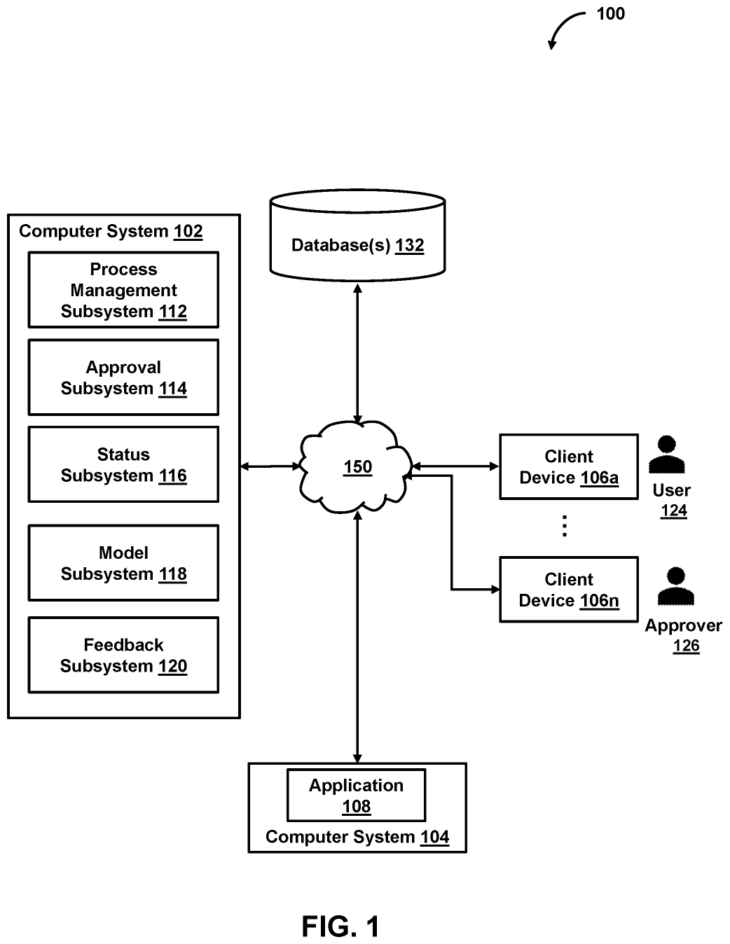

FIG. 1 shows a system 100 for facilitating approval of an approval request using an application-independent processing system, in accordance with one or more embodiments. For example, system 100 may comprise an improved processing architecture in networked computer systems. In particular, system 100 may include a new function routine that automatically approves an approval request based on pre-authorized approval information provided by an approver. As shown in FIG. 1, system 100 may include computer system 102, computer system 104, client device 106 (or client devices 106a-106n), or other components. By the way of example, computer system 102 and the computer system 104 may include any computing device, such as a personal computer (PC), a laptop computer, a tablet computer, a hand-held computer, other computer equipment. Computer system 102 may include process management subsystem 112, approval subsystem 114, status subsystem 116, model subsystem 118, feedback subsystem 120, or other components. Computer system 104 may host one or more applications, such as application 108, that consumes process management services provided by computer system 102. Each client device 106 may include any type of mobile terminal, fixed terminal, or other device, By way of example, client device 106 may include a desktop computer, a notebook computer, a tablet computer, a smartphone, a wearable device, or other client device. Users may, for instance, utilize one or more client devices 106 to interact with one another, one or more servers, or other components of system 100.

A component of system 100 may communicate with one or more components of system 100 via a communication network 150 (e.g., Internet, a mobile phone network, a mobile voice or data network, a cable network, a public switched telephone network, or other types of communications network or combinations of communications networks). The communication network 150 may be a wireless or wired network. As an example, the computer system 104 may interact with the computer system 102 via the above described communication network. As another example, the client device 106 and the computer system 102 may communicate wirelessly.

It should be noted that, while one or more operations are described herein as being performed by particular components of computer system 102, those operations may, in some embodiments, be performed by other components of computer system 102 or other components of system 100. As an example, while one or more operations are described herein as being performed by components of computer system 102, those operations may, in some embodiments, be performed by components of client device 106 or components of computer system 104.

It should be noted that, although some embodiments are described herein with respect to machine learning models, other prediction models (e.g., statistical models or other analytics models) may be used in lieu of or in addition to machine learning models in other embodiments (e.g., a statistical model replacing a machine learning model and a non-statistical model replacing a non-machine-learning model in one or more embodiments).

In some embodiments, system 100 provides process management capabilities (e.g., creation of a process, processing an approval request to approve or reject the approval request or other such capabilities) to various applications. A process may be defined as a series of activities or tasks that need to be completed (e.g., sequentially or in parallel) to achieve an outcome. For example, an approval request for a product or service may be a process, which include a series of activities (e.g., approval by one or more approvers) to be performed to fulfill the request (e.g., provide the product or service to a requesting user). System 100 facilitates applications to implement processes using an application-independent processing system (e.g., computer system 102). For example, system 100 facilitates an application, such as an application 108 (e.g., product/service request application) to implement a process using a configuration file. The application 108 may implement a process by defining process parameters in the configuration file. The process parameters may include information such as a number of approval levels required to approve an approval request, information regarding approvers in each approval level (e.g., name, e-mail, mobile phone number or other such information) or a function to determine the approvers in the approval levels, information regarding content to be included in an approval notification to an approver, or other such parameters. Each application or each process in an application may define its own process parameters in the configuration file. In some embodiments, each configuration file may correspond to a single process.

Upon receiving an approval request from the application 108 (e.g., a user 124 of the application 108), the system 100 obtains a configuration file associated with the process corresponding to the approval request, obtains information regarding approvers authorized to approve the approval request from the configuration file and send approval notifications (e.g., via email, text or other notification) to the approvers (e.g., approver 126). Upon receiving the response from the approvers, the system 100 may update the status of the approval request (e.g., approved, rejected, pending or other status information) in the database 132 and send a notification to the user 124 accordingly.

In some embodiments, the system 100 may also facilitate automatic approval of approval request. For example, the system 100 facilitates the approver 126 to provide pre-authorized approval information that may be used for automatically approving an approval request received subsequent to providing the pre-authorized approval information. The system 100 may also facilitate the approver 126 to define conditions in the pre-authorized approval information for automatically approving the approval requests. For example, the condition may specify parameters that an approval request may have to satisfy for the approval request to be automatically approved. The parameters may include user related parameters (e.g., username, user ID, user designation in an organization, or other such user parameters), product/service-related parameters (e.g., product/service name, configuration, type, etc.), date or period the approval request has to be received, or other such parameters. As an example, the pre-authorized approval information may indicate that an approval request from a user with user ID “abc123” for a laptop made by “Dell” and configuration “13 inches” may be automatically approved whenever the approval request is received from the user.

In some embodiments, the system 100 may use a machine learning model in determining a likelihood of approval by an approver. The likelihood may be represented as an approval score and this approval score may be used as a reference by the approver in determining whether to approve or reject the approval request. The approval score may also be used in determining whether to automatically approve or reject the approval request. For example, the approver may define a threshold score in the pre-authorized approval information that the score may have to satisfy for automatic approval. In some embodiments, system 100 may use a machine learning model to predict a sentiment of the approver in approving or rejecting an approval request. Typically, a prediction of positive sentiment (e.g., “user eligible for requested product,” “approved,” “proceed,” “ok” or other such positive sentiments) may be indicative of an approval of the approval request, and a prediction of negative sentiment (e.g., “user not eligible for requested product,” “requested amount too high,” “non-reimbursable expense,” or other such negative sentiments) may be indicative of a rejection of the approval request by the approver. Similar to the approval score, the predicted sentiment may be provided to the approver as a reference to assist the approver in making a decision to approve or reject the approval request. The sentiment may also be used in determining whether to automatically approve or reject an approval request. For example, the approver may define an expected sentiment in the pre-authorized approval information that the approval request may have to satisfy for automatic approval.

In some embodiments, the system 100 may train a first prediction model to determine the approval score of an approval request. System 100 may obtain approval requests reviewed (e.g., approved or rejected) by the approver 126 and input them as training information to a prediction model to generate prediction data related to the approval score. As an example, the training information may include request parameters such as user parameters related to a user associated with the approval request, product/service parameters related to a product/service requested in the approval request, or other such parameters. The first prediction model may generate prediction data related to the score based on the above training information. For example, the prediction data may include an approval score that is indicative of a likelihood of approval of an approval request. In some embodiments, actual information such as whether the approval request is approved or rejected for each of the approval requests in the training information may be provided as reference feedback to the prediction model. As an example, the reference feedback may indicate that an approval request is approved by the approver 126. As another example, the reference feedback may indicate that an approval request is approved after one or more request parameters were changed by the approver 126. The first prediction model may update one or more portions of the first prediction model based on the prediction data and the reference feedback information. In this way, for example, the first prediction model may be trained or configured to generate more accurate predictions.

As such, in some embodiments, subsequent to the updating of the prediction model, system 100 may use the prediction model to process an approval request to predict an approval score. As an example, system 100 may obtain an approval request from user 124 (e.g., received from the application 108, or from another source) and provide the approval request to the prediction model to obtain a prediction related to an approval score.

In some embodiments, similar to the first prediction model for predicting the approval score, the system 100 may train a second prediction model to determine a sentiment of an approver for an approval request. System 100 may obtain approval requests reviewed (e.g., approved or rejected) by the approver 126 and input them as training information to a second prediction model to generate prediction data related to the approval score. As an example, the training information may include request parameters such as user parameters related to a user associated with the approval request, product/service parameters related to a product/service requested in the approval request, comments provided by the approver in rejecting or approving the approval request, or other such parameters. The second prediction model may generate prediction data related to the sentiment based on the above training information. For example, the prediction data may include a sentiment indicator that is indicative of a sentiment (e.g., positive or negative) in approving or rejecting an approval request. In some embodiments, actual information such as whether the approval request is approved or rejected for each of the approval requests in the training information may be provided as reference feedback to the second prediction model. As an example, the reference feedback may indicate that an approval request is approved by the approver 126. As another example, the reference feedback may indicate that an approval request is approved after one or more request parameters were changed by the approver 126. The second prediction model may update one or more portions of the prediction model based on the prediction data and the reference feedback information. In this way, for example, the second prediction model may be trained or configured to generate more accurate predictions.

As such, in some embodiments, subsequent to the updating of the prediction model, system 100 may use the second prediction model to process an approval request to predict a sentiment of the approver for an approval request. As an example, system 100 may obtain an approval request from user 124 (e.g., received from the application 108, or from another source) and provide the approval request to the second prediction model to obtain a prediction related to a sentiment of the approver for the approval request.

In some embodiments, the prediction model may include one or more neural networks or other machine learning models. As an example, neural networks may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections can be enforcing or inhibitory in their effect on the activation state of connected neural units. In some embodiments, each individual neural unit may have a summation function which combines the values of all its inputs together. In some embodiments, each connection (or the neural unit itself) may have a threshold function such that the signal must surpass the threshold before it propagates to other neural units. These neural network systems may be self-learning and trained, rather than explicitly programmed, and can perform significantly better in certain areas of problem solving, as compared to traditional computer programs. In some embodiments, neural networks may include multiple layers (e.g., where a signal path traverses from front layers to back layers). In some embodiments, back propagation techniques may be utilized by the neural networks, where forward stimulation is used to reset weights on the “front” neural units. In some embodiments, stimulation and inhibition for neural networks may be more free-flowing, with connections interacting in a more chaotic and complex fashion.

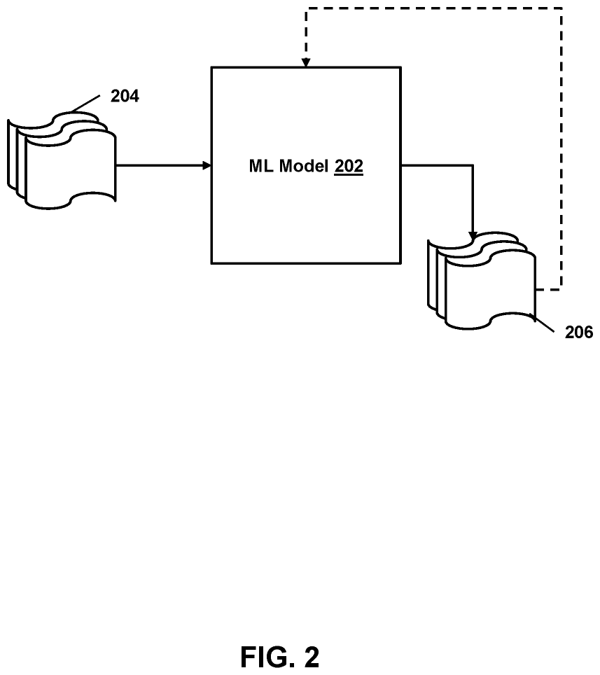

As an example, with respect to FIG. 2, machine learning model 202 may take inputs 204 and provide outputs 206. In one use case, outputs 206 may be fed back to machine learning model 202 as input to train machine learning model 202 (e.g., alone or in conjunction with user indications of the accuracy of outputs 206, labels associated with the inputs, or with other reference feedback information). In another use case, machine learning model 202 may update its configurations (e.g., weights, biases, or other parameters) based on its assessment of its prediction (e.g., outputs 206) and reference feedback information (e.g., user indication of accuracy, reference labels, or other information). In another use case, where machine learning model 202 is a neural network, connection weights may be adjusted to reconcile differences between the neural network's prediction and the reference feedback. In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error propagated backward after a forward pass has been completed. In this way, for example, the machine learning model 202 may be trained to generate better predictions.

### Subsystems 112-120

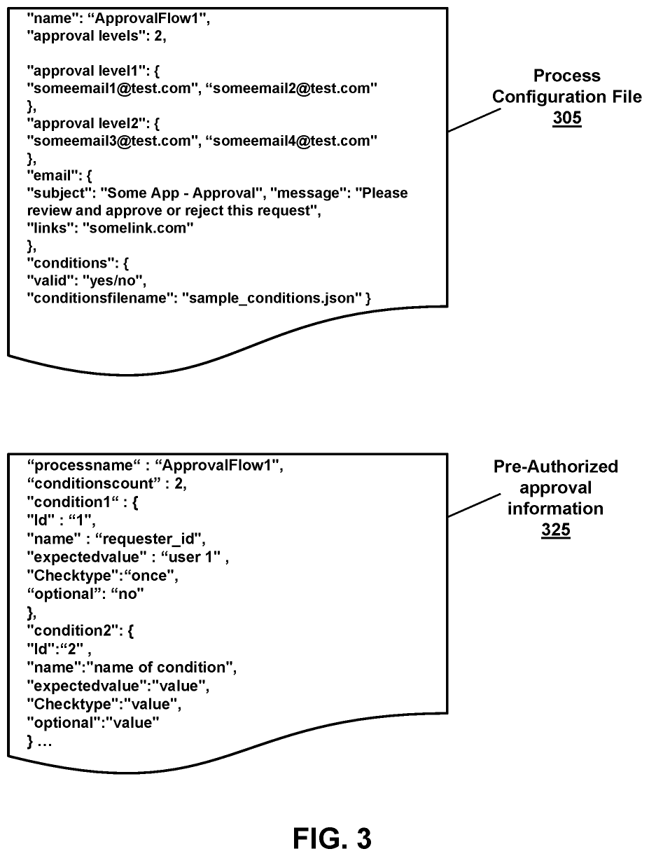

In some embodiments, process management subsystem 112 facilitates managing a process. As an example, an application, such as application 108, may define a process in a configuration file, such as configuration file 305 illustrated in FIG. 3. An entity associated with the application 108 (e.g., an administrator of the application 108, or other entity) may access a graphical user interface (GUT) associated with the process management subsystem 112 to define the process parameters and generate the configuration file 305. The configuration file 305 may include process parameters that are characteristic of the process. For example, a name parameter indicates a name or other identification (ID) of the process. The approval levels parameter indicates a number of approval levels in the process. The configuration file 305 also indicates information related to approvers (e.g., name, email ID, mobile phone number, or other approver related information) in each approval level. The configuration file 305 may also include notification parameter that may specify the information to be provided in an approval request notification sent to the approver. The configuration file 305 may also include a conditions parameter that indicates whether the process is associated with pre-authorized approval information and a name of a file having the conditions for pre-authorized approval.

The process management subsystem 112 may also facilitate the application 108 to define a function in the configuration file 305 that is configured to determine the approvers for one or more approval levels dynamically (e.g., upon receipt of an approval request). The function may be configured to determine an approver in a number of ways. In some embodiments, the function may be configured to determine the approver based on a seniority of an employee in an organization, a role of the employee, a designation of the employee, an organization hierarchy, a group/team/department to which a user who generated the approval request belongs, or other such factors. In some embodiments, the function may be configured to determine an approver based on the availability or non-availability of an employee. For example, if the function determines that a first approver is unavailable (e.g., based on time-off data available from an organization database), the function may assign the approval request to a second approver instead of the first approver. In some embodiments, the function may be configured to determine an approver based on a number of pending approval requests in a queue associated with the approver. For example, if the number of pending approval requests exceeds a threshold number, the function may assign the approval request to another approver.

In some embodiments, the process management subsystem 112 may facilitate the approver 126 to provide pre-authorized approval information for a process, which may be used for automatically approving approval requests without the approver 126 having to manually review and approve the approval request. The approver 126 may use the GUI provided by the process management subsystem 112 to specify the pre-authorized approval information. The process management subsystem 112 may store the pre-authorized approval information in a file or in a table in the database 132. The pre-authorized approval information may be of various configurations. For example, the pre-authorized approval information may not include any conditions for automatic approval of an approval request in which case any approval request corresponding to the process may be approved automatically regardless of the request parameters.

In another example, the approver 126 may define conditions in the pre-authorized approval information, as illustrated in FIG. 3, which an approval request has to satisfy for automatic approval. The pre-authorized approval information 325 may include (a) a process name or process ID for which the pre-authorized approval information corresponds, (b) a condition count that indicates a number of conditions defined in the pre-authorized approval information, (c) the condition, or other such information. A condition may have one or more parameters such as a condition ID, a name parameter, an expected value parameter, a check type parameter, a condition optional parameter, or other parameters. The name parameter indicates a name or other identification information of a request parameter that has to be analyzed for automatic approval. The expected value parameter indicates an expected value of the request parameter specified in the name parameter for automatic approval. The check type parameter indicates whether the condition has to be checked at one approval level (e.g., first approval level) or every approval level, The condition optional parameter indicates whether checking of the condition is optional or mandatory for automatic approval. In the example of FIG. 3, the “condition1” of pre-authorized approval information 325 has a name parameter with the value “requester_id” and the expected value “user 1,” which indicates that “condition1” will be satisfied if the user ID of the user associated with the approval request is “user 1.” If the approver 126 intends to provide a pre-authorization for automatically approving a request from user “user 1” for a laptop of brand “brand1,” then the pre-authorized approval information 325 may have two conditions. The first condition may specify a name parameter with the value “requester_id” and the expected value “user 1,” and the second condition may specify a name parameter with the value “brand_id” and the expected value “brand1” for the approval request to be approved automatically.

In some embodiments, the pre-authorized approval information 325 may also include a threshold approval score or approver sentiment that the approval request may have to satisfy for automatic approval. For example, the pre-authorized approval information 325 may include a threshold approval score (e.g., a value or a range of values) that a predicted approval score of an approval request may have to satisfy (e.g., exceed or match) for automatic approval. Further, the threshold approval score may be configured to adjusted based on one or more factors, such as length of time since the approval request was submitted. For example, the threshold approval score may be higher if the approval request is more recent (e.g., right after the approval request is submitted by the user) and may be reduced to a lower value if the approval request is less recent (e.g., a week, two weeks, or another duration has elapsed since the approval request was submitted). In some embodiments, the threshold approval score may be defined as a score range. Note that the threshold score may be used in the pre-authorized approval information 325 for automatic approval, or may be presented to the approver 126 as a reference to help the approver 126 in determining whether to approve or reject the approval request. The threshold score may be automatically determined by the process management subsystem 112 or may be defined by the approver 126. In some embodiments, the approver 126 may adjust the threshold score based on one or more factors. For example, if the approver 126 is expecting to be unavailable during a specified period, then the approver 126 may adjust the threshold score to a lower range than usual to have most of the approval requests automatically approved without any user intervention from the approver 126.

Similar to the expected approval score, the pre-authorized approval information 325 may also include an expected sentiment of the approver that a predicted sentiment for an approval request may have to satisfy (e.g., exceed) for automatic approval. For example, if the expected sentiment is indicated as positive, then the predicted sentiment for an approval request may have to be positive for the approval request to be automatically approved. Note that the expected sentiment may be used in the pre-authorized approval information 325 for automatic approval, or may be presented to the approver 126 as a reference to help the approver 126 in determining whether to approve or reject the approval request.

In some embodiments, the pre-authorization approval information may be associated with a validity period, which identifies the period for which the pre-authorization approval information is valid. For example, when an approval request is received, if the pre-authorization approval information is not valid, then the approval request may be automatically rejected or may be forwarded to an approver for reviewing the approval request.

In some embodiments, the approval subsystem 114 facilitates processing of an approval request from an application. For example, the approval subsystem 114 receives a first approval request from the application 108 (e.g., initiated by the user 124 of the application 108) and either notifies the approvers to review and approve or reject the first approval request, or automatically approves or rejects the first approval request based on the pre-authorized approval information without any user intervention from the approvers.

Upon receiving the first approval request, the approval subsystem 114 extracts the process ID from the first approval request and obtains the configuration file, such as the configuration file 305, from the database 132 based on the process ID. The approval subsystem 114 obtains information regarding the approvers from the configuration file and determines whether an approver has provided a pre-authorization approval, such as the pre-authorized approval information 325, for approving the first approval request automatically. If no pre-authorization approval is provided, a notification (e.g., email, text, or other notification) is sent to the approver. The notification may include information regarding the first approval request such as requesting user, subject of the request, a link to the first approval request in the application 108, or other such information that may be needed for the approver to approve the first approval request. The approver 126 may access the first approval request using the information provided in the notification. As an example, the approval subsystem 114 may provide a GUI that may display various information regarding the first approval request to the approver. For example, the GUI may present request parameters, such as user related parameters (e.g., user ID, name, email, or other information) of the user who initiated the first approval request, product/service-related parameters of a product or service requested (e.g., name of product, configuration of product, price of the product, or other information). In some embodiments, the GUI may also display the predicted approval score or predicted approver sentiment for the first approval request, which the approver may use as reference for determining whether to approve or reject the first approval request.

The approval subsystem 114 may use a prediction model to generate prediction data related to the approval score or approver sentiment. In some embodiments, the first approval request may be provided as input to a first prediction model and the first prediction model may generate the prediction data related to the approval score. In some embodiments, a collection of approval items approved or rejected by the approver 126 may be obtained and input to the first prediction model as training information to train the first prediction model. Such information may be stored by computer system 102 in a storage system (e.g., database 132). In the training process, the model subsystem 118 may obtain the training information from the database 132 and provide it as input to the first prediction model to generate the predictions. Feedback subsystem 120 may provide result information as reference feedback to the first prediction model, and the first prediction model may update its configurations (e.g., weights, biases, or other parameters) based on an assessment of the predictions against the result information. As an example, the predictions generated by the first prediction model may be indicative of an approval score for an approval request, and the result information may include actual data related to whether the approval request is approved or rejected. In some embodiments, subsequent to the updating of the first prediction model, the first prediction model may be used to predict an approval score of the approval request for a specific approver. As an example, the first approval request (e.g., received from the computer system 104, or from another source) may be provided to the first prediction model to obtain a prediction related to an approval score for the first approval request.

Similarly, for the prediction related to the approver sentiment, approval subsystem 114 may perform sentiment analysis to determine the sentiment associated with the approver in approving or rejecting the first approval request. As an example, the approval subsystem 114 may provide the first approval request as input to a second prediction model to obtain the prediction data related to the approver sentiment. As an example, comments associated with the approval or rejection of approval requests similar to the first approval request may be provided as input to a second prediction model to obtain a polarity (e.g., a positive or negative sentiment) within word, phrase, sentence, or clause of the comments. In some embodiments, feelings and emotions (e.g., angry, happy, sad, etc.) may also be obtained from the second prediction model. In some embodiments, the second prediction model may use various Natural Language Processing (NLP) methods or other methods to determine the sentiment. As an example, the second prediction model may use a set of user-defined rules (e.g., rules defined by an administrator associated with system 100 or other user) to identify the sentiment. These rules may define two lists of polarized words (e.g., negative words such as bad, worst, ineligible, etc., and positive words such as good, best, ok, etc.). The second prediction model may count the number of positive and negative words that appear in an input text (e.g., comments) and determine a negative sentiment based on the number of negative word appearances in the input text being greater than the number of positive word appearances, and vice versa.

As another example, the second prediction model may be trained to classify the input text into a category (e.g., a positive, negative, or neutral sentiment). In the training process, the model subsystem 118 may extract feature vectors from a particular input (e.g., approval request parameters and a comment associated with the approval request) and a label associated with the corresponding input, such as a negative, positive, or neutral sentiment, are fed to the second prediction model as feature vector and label pairs. Feedback subsystem 120 may provide result information as reference feedback to the second prediction model, and the second prediction model may update its configurations (e.g., weights, biases, or other parameters) based on an assessment of the predictions against the result information (e.g., label associated with an approval request). The second prediction model learns to associate each of the feature vectors to the corresponding label based on the training information (e.g., approval request parameters, comments and associated labels) used for training. As such, in some embodiments, subsequent to the training of the second prediction model, the second prediction model may be used to predict an approver sentiment for approving an approval request. In the prediction process, a feature vector of an unseen text is extracted and input to the second prediction model, which generates a predicted label (e.g., a positive, negative, or neutral sentiment). As an example, the request parameters of the first approval request (e.g., received from the computer system 104, or from another source) may be provided to the second prediction model to obtain a prediction related to the approver sentiment for the first approval request.

As described above, the approver 126 may use the predicted approval score or predicted approver sentiment as a reference for determining whether to approve or reject the first approval request. In some embodiments, if the predicted approval score does not satisfy a threshold score (e.g., which may be determined by the process management subsystem 112 or the approver), the approver 126 may approve the first approval request after modifying one or more request parameters such that the predicted approval score satisfies the threshold score. For example, if the first approval request is for issuing a laptop of a first brand, “brand1,” and the predicted approval score does not satisfy the threshold score, the approver 126 may change the first brand, “brand1,” to a second brand “brand2,” which is less expensive than “brand1,” and then approve the first approval request.

While the foregoing paragraphs describe approval or rejection of the first approval request by the approver 126, in some embodiments, the first approval request may be automatically approved or rejected without user intervention from the approver 126. For example, the approval subsystem 114 may automatically approve or reject the first approval request based on pre-authorization approval information provided by the approver 126 for a process to which the first approval request corresponds. In some embodiments, the approval subsystem my obtain the pre-authorization approval information provided by the approver 126 based on the process ID (e.g., extracted from the first approval request) and the approver 126 information (e.g., obtained from the configuration file). The approval subsystem 114 determines whether the pre-authorization approval information has expired (e.g., based on a validity date associated with the pre-authorization approval information). If the pre-authorization approval information has expired, the approval subsystem 114 may automatically reject the approval request or notify the approver to review the first approval request, lithe pre-authorization approval information has not expired, the approval subsystem 114 determines whether any conditions for automatic approval are provided in the pre-authorization approval information, there are no conditions, the approval subsystem 114 automatically approves the first approval request regardless of the values of the request parameters in the first approval request. On the other hand, if the pre-authorization approval information includes conditions, the approval subsystem 114 determines whether the request parameters of the first approval request satisfy the conditions.

In some embodiments, a condition may include a name parameter (e.g., a request parameter name), an expected value parameter (e.g., the expected value of the request parameter), threshold approval score, expected approver sentiment, or other parameters, The approval subsystem 114 may approve the first approval request automatically if the request parameters satisfy the conditions, else reject the first approval request. As an example, if a first condition specifies that “requester_id” parameter should have an expected value of “user 1,” and a second condition specifies that the “brand_id” request parameter should have an expected value of “brand1,” the approval subsystem 114 may determine that an approval request from user “user 1” for a laptop of brand “brand 1” satisfies the conditions and therefore, automatically approve the approval request.

In some embodiments, the approval subsystem 114 may be configured to approve an approval request by modifying the request parameters instead of rejecting the approval request if a condition is not satisfied. For example, if the predicted approval score does not satisfy the threshold score, the approval subsystem 114 may approve the first approval request after modifying one or more request parameters such that the predicted approval score satisfies the threshold score. For example, if the first approval request is a reimbursement request from the user 124 for “$100,” and the predicted approval score does not satisfy the threshold score, the approval subsystem 114 may automatically adjust the request parameter (e.g., reimbursement amount) to a lower value, e.g., “$50,” such that the predicted approval score now satisfies the threshold score, and then approve the modified first approval request. In some embodiments, the approval subsystem 114 may have access to rules regarding products or services the user 124 is eligible to request, and the approval subsystem 114 may be configured to change the request parameters based on such information.

While the foregoing describes the approval process by a single approver, the approval process may include obtaining approvals multiple approvers. For example, if the configuration file indicates multiple approval levels, then the approval may have to obtained (e.g., automatically using pre-authorized approval information or from corresponding approvers) each of the approvers. The approval may be obtained from the approvers sequentially or in parallel. For example, if the configuration file indicates “3” approval levels, then the approval may have to be obtained from “3” approvers. In the sequential example, the first approval request is processed with respect to a first approver (e.g., for manual or automatic approval), then with respect to a second approver, and then with respect to a third approver. In the simultaneous or in parallel example, the request is processed with respect to all the “3” approvers simultaneously. The first approval request may be considered to be approved or rejected based on the responses associated with all the “3” approvers. In some embodiments, the first approval request is considered to be approved if an approval is received from at least one approver, a majority of approvers, all approvers, or other combination of approvers. In some embodiments, if the first approval request is rejected at the first approval level, the first approval request may be considered rejected and may not be sent to the remaining approval levels.

In some embodiments, status subsystem 116 updates status information of an approval request. For example, status subsystem 116 may update status information such as a current approval level the first approval request is at, an approval status of the first approval request (e.g., approved, rejected, pending, or other information), or a correlation ID of the first approval request that correlates the first approval request with a process, component or another entity within the application 108 that initiated the first approval request. The status subsystem 116 may store the status information in a storage system (e.g., database 132). In sonic embodiments, after updating the status information, the status subsystem 116 may also send a notification (e.g., email, text, or other notification) informing a status of the first approval request to the user 124 who initiated the first approval request.

### Example Flowchart(s)

The example flowchart(s) described herein of processing operations of methods that enable the various features and functionality of the system as described in detail above. The processing operations of each method presented below are intended to be illustrative and non-limiting. In some embodiments, for example, the methods may be accomplished with one or more additional operations not described, and/or without one or more of the operations discussed. Additionally, the order in which the processing operations of the methods are illustrated (and described below) is not intended to be limiting.

In some embodiments, the methods may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

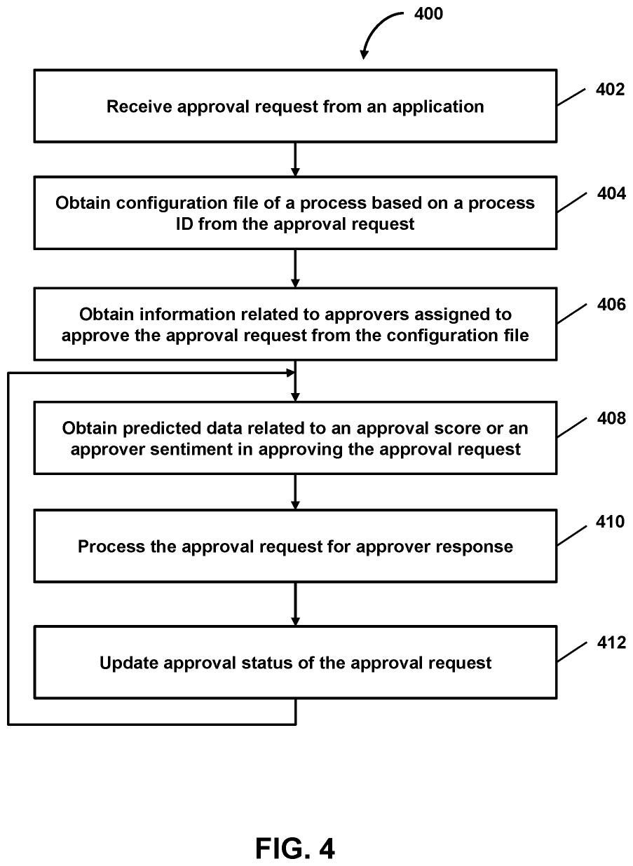

FIG. 4 shows a flowchart of a method 400 for processing an approval request using an application-independent processing system, in accordance with one or more embodiments. For example, method 400 may comprise steps performed by an improved processing architecture in networked computer systems. In particular, method 400 may include a new function routine that automatically approves an approval request based on pre-authorized approval information provided by an approver. In an operation 402, an approval request is received from an application. For example, the user 124 associated with the application 108 may initiate an approval request using client device 106a. The approval request may be a request for reimbursement of an expense in the amount of “$100.”

Operation 402 may be performed by a component that is the same as or similar approval subsystem 114, in accordance with one or more embodiments.

In an operation 404, a configuration file corresponding to a process of the approval request is obtained from a storage system. For example, a process ID that is representative of a process to which the approval request corresponds is extracted from the approval request, and then the configuration file associated with the process ID is obtained from the database 132. For example, the configuration file 305 may include process parameters that are characteristic of the process, such as the process ID, approval levels parameter, information related to approvers (e.g., name, email ID, mobile phone number, or other approver related information) in each approval level that are authorized to approve the request, or other such parameters.

Operation 404 may be performed by a component that is the same as or similar to the approval subsystem 114, in accordance with one or more embodiments.

In an operation 406, information related to an approver in an approval level is obtained from the configuration file. For example, information such as email ID of the approver is obtained from the configuration file 305. In some embodiments, the configuration file may include a function that is configured to determine an approver for an approval level dynamically (e.g., upon receipt of an approval request). The function may be configured to determine an approver based on a seniority of an employee in an organization, a role of the employee, a designation of the employee, an organization hierarchy, a group/team/department to which a user who generated the approval request belongs, or other such factors. The function may be configured to determine an approver based on the availability or non-availability of an employee. For example, if the function determines that a first approver is unavailable (e.g., based on time-off data available from an organization database), the function may assign the approval request to a second approver instead of the first approver. The function may be configured to determine an approver based on a number of pending approval requests in a queue associated with the approver. For example, if the number of pending approval requests exceeds a threshold number, the function may assign the approval request to another approver. In some embodiments, more than one approver may be mentioned in an approval level in the configuration file in which case the approval subsystem 114 selects one of the approvers from that approval level.

Operation 406 may be performed by a component that is the same as or similar to the approval subsystem 114, in accordance with one or more embodiments.

In an operation 408, predicted data related to an approval score and an approver sentiment is obtained. In some embodiments, the approval score is indicative of a likelihood of approval of the approval request by the approver. The approval score can be expressed in various formats. For example, the approval score can be in the range of 0 to 1, −1 to +1, 1 to 100, or other such ranges in which the greater the number the greater the likelihood of approval. In some embodiments, the approver sentiment is indicative of a sentiment (e.g., positive) of the approver in approving the approval request. The approver sentiment may be expressed in various formats. For example, the approver sentiment may be in the range of 0 to 1, −1 to +1, or other such ranges in which the greater the number the more positive is the sentiment of the approver. The predictions related to the approval score or the approver sentiment may be obtained from prediction models, For example, an approval score may be obtained by inputting the approval request to a first prediction model that is trained to generate a prediction related to the approval score. Similarly, an approver sentiment may be obtained by inputting the approval request to a second prediction model that is trained to generate a prediction related to the approver sentiment.

Operation 408 may be performed by a component that is the same as or similar to the approval subsystem 114, in accordance with one or more embodiments.

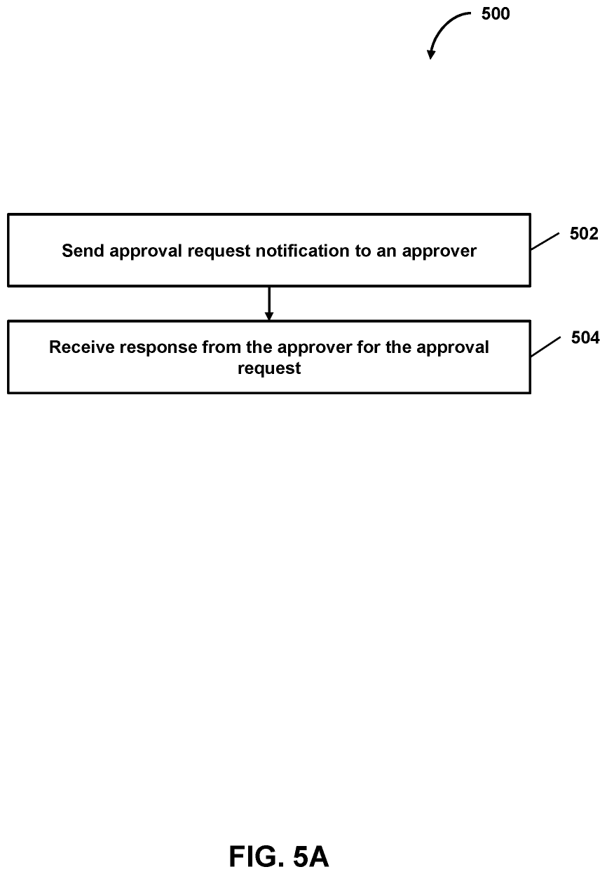

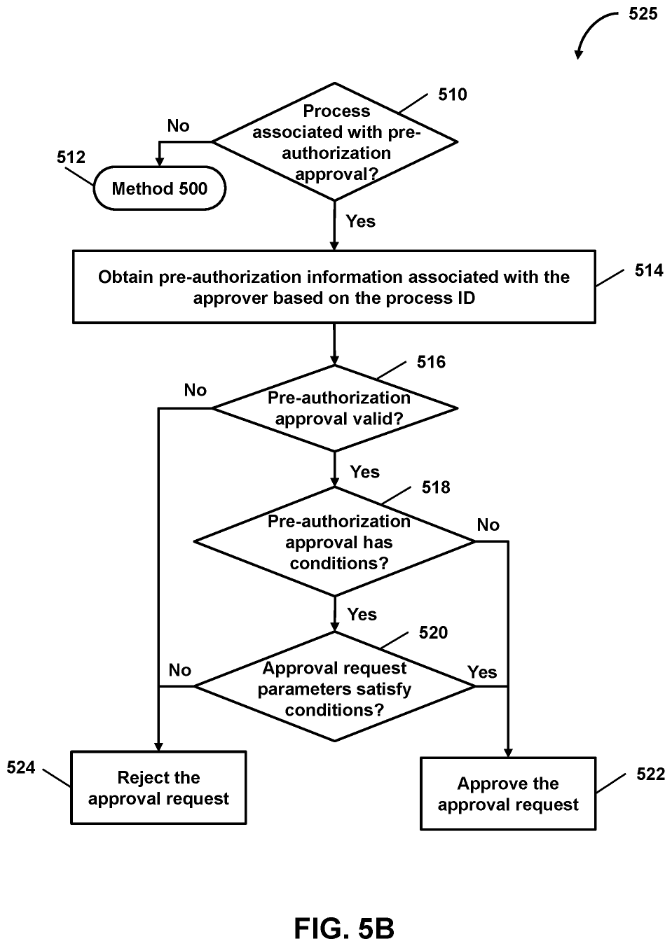

In an operation 410, the approval request is processed to obtain approver response. In some embodiments, processing of the approval request may include sending the approval request to the approver and obtaining a response (e.g., approval or rejection) from the approver, or automatically approving or rejecting the approval request based on the pre-authorized approval information provided by the approver. Additional details of processing the approval request is described at least with reference to FIGS. 5A and 5B below. For example, FIGS. 5A and 5B comprise steps performed by an improved processing architecture in networked computer systems. As shown, FIGS. 5A and 5B include a new function routine that automatically approves an approval request based on pre-authorized approval information provided by an approver.

Operation 410 may be performed by a component that is the same as or similar to the approval subsystem 114, in accordance with one or more embodiments.

In an operation 412, status information of an approval request is updated. For example, status information such as a current approval level the approval request is at, an approval status of the approval request (e.g., approved, rejected, pending, or other information), or other such information is stored in a storage system (e.g., database 132).

Operation 412 may be performed by a component that is the same as or similar to the status subsystem 116, in accordance with one or more embodiments.

In some embodiments, the operations 408-412 may be repeated for each approval level to obtain a response from the approver of the corresponding approval level. For example, if the number of approval levels defined in the configuration file is “3,” the operations 408-412 is executed “3” times—once for each of the “3” approval levels.

FIG. 5A shows a flowchart of a method 500 for processing an approval request to obtain approver response, in accordance with one or more embodiments. In some embodiments, the method 500 may be implemented as part of operation 410 of method 400. In an operation 502, an approval request notification is sent to an approver. For example, the notification may be sent via email and may include information regarding the approval request such as requesting user, subject of the request, a link to the approval request in the application 108, or other such information that may be needed for the approver to approve the approval request. The approver 126 may access the approval request using the information provided in the notification. As an example, upon accessing the link in the notification a GUI that presents the approval request information to the approver may be rendered on a client device 106 associated with the approver. For example, the GUI may present request parameters, such as user related parameters (e.g., user ID, name, email, or other information) of the user who initiated the approval request, product/service-related parameters of a product or service requested (e.g., name of product, configuration of product, price of the product, or other information). In some embodiments, the GUI may also display the predicted approval score or predicted approver sentiment for the approval request, which the approver may use as a reference for determining whether to approve or reject the first approval request.

Operation 502 may be performed by a component that is the same as or similar to the approval subsystem 114, in accordance with one or more embodiments.

In an operation 504, a response is received from the approver, and the method 500 returns to operation 412 in the method 400. The response may include an approval or rejection of the approval request. In some embodiments, as described above, the approver may adjust a request parameter and then approve the approval request. For example, if the claimed reimbursement amount in the approval request is “$100,” and the predicted approval score does not satisfy the threshold score, the approver 126 may adjust the request parameter (e.g., reimbursement amount) to a lower value, e.g., “$50,” such that the predicted approval score now satisfies the threshold score, and then approve the modified approval request.

Operation 504 may be performed by a component that is the same as or similar to the approval subsystem 114, in accordance with one or more embodiments.

FIG. 5B shows a flowchart of a method 525 for automatically approving an approval request based on pre-authorized approval information, in accordance with one or more embodiments. In some embodiments, the method 525 may be implemented as part of operation 410 of method 400. In an operation 510, a determination is made whether a process corresponding to the approval request is associated with a pre-authorized approval information provided by an approver. For example, the storage system may be queried based on the process ID and the approver information (e.g., approver ID) to determine if the process is associated with pre-authorized approval information.

Based on a determination that no pre-authorized approval information is provided by the approver for the process, in an operation 512, the control is transferred to process 500.

Based on a determination that the process is associated with pre-authorized approval information of the approver, in an operation 514, the pre-authorized approval information is obtained. The pre-authorization may be stored in a storage system (e.g., database 132).

In an operation 516, a determination is made whether the pre-authorized approval information is valid. In some embodiments, the pre-authorization approval information may be associated with a validity period, which identifies the period for which the pre-authorization approval information is valid.

Based on a determination that the pre-authorized approval information is not valid on the date or time the approval request is received, in an operation 524, the approval request may be rejected.

Referring to operation 516, based on a determination that the pre-authorized approval information is valid, in an operation 518, a determination is made whether the pre-authorized approval information includes any conditions for automatic approval of the approval request.

Based on a determination that the pre-authorized approval information has no conditions, in an operation 522, the approval request is automatically approved without any user intervention from the approver.

Referring to operation 518, based on a determination that the pre-authorized approval information has conditions, in an operation 520, a determination is made whether the request parameters of the approval request satisfy the conditions. In some embodiments, a condition may have one or more parameters such as a condition ID, a name parameter, an expected value parameter, a check type parameter, a condition optional parameter, or other parameters. The name parameter indicates a name or other identification information of a request parameter that has to be analyzed for automatic approval. The expected value parameter indicates an expected value of the request parameter specified in the name parameter for automatic approval. The check type parameter indicates whether the condition has to be checked at one approval level (e.g., first approval level) or every approval level. The condition optional parameter indicates whether checking of the condition is optional for automatic approval. In some embodiments, the pre-authorized approval information may also include a threshold approval score or approval sentiment that the predicted approval score or the predicted approver sentiment of the approval request may have to satisfy for automatic approval of the approval request.

Based on a determination that the request parameters satisfy the conditions, in an operation 522, the approval request is automatically approved without any user intervention from the approver.

Referring to operation 520, based on a determination that the request parameters do not satisfy the conditions, in an operation 524, the approval request is automatically rejected without any user intervention from the approver.

In some embodiments, the various computers and subsystems illustrated in FIG. 1 may include one or more computing devices that are programmed to perform the functions described herein. The computing devices may include one or more electronic storages (e.g., prediction database(s) 132, or other electronic storages), one or more physical processors programmed with one or more computer program instructions, and/or other components. The computing devices may include communication lines or ports to enable the exchange of information within a network (e.g., network 150) or other computing platforms via wired or wireless techniques (e.g., Ethernet, fiber optics, coaxial cable, Bluetooth, near field communication, or other technologies). The computing devices may include a plurality of hardware, software, and/or firmware components operating together. For example, the computing devices may be implemented by a cloud of computing platforms operating together as the computing devices. Cloud components may include control circuitry configured to perform the various operations needed to implement the disclosed embodiments. Cloud components may include cloud-based storage circuitry configured to electronically store information. Cloud components may also include cloud-based input/output circuitry configured to display information.

The electronic storages may include non-transitory storage media that electronically stores information. The storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media. (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein of subsystems 112-120 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 112-120 described herein is for illustrative purposes, and is not intended to be limiting, as any of subsystems 112-120 may provide more or less functionality than is described. For example, one or more of subsystems 112-120 may be eliminated, and some or all of its functionality may be provided by other ones of subsystems 112-120. As another example, additional subsystems may be programmed to perform some or all of the functionality attributed herein to one of subsystems 112-120.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The present techniques will be better understood with reference to the following enumerated embodiments:

1. A method comprising: obtaining a first approval request from a first application, the first approval request including request parameters such as user parameters related to a user associated with the first approval request or product/service parameters related to a product/service requested in the first approval request; determining a first approver for approving the first approval request based on a first configuration file associated with a first approval process corresponding to the first approval request; obtaining first pre-authorized approval information associated with the first approver, wherein the first pre-authorized approval information includes a first condition for approving the first approval request; and causing the first approval request to be automatically approved, without user intervention from the first approver, based on the request parameters satisfying the first condition.
2. The method of any of the preceding embodiments, wherein the first configuration file is representative of the first approval process and obtained based on a first process ID in the first approval request.
3. The method of any one of the preceding embodiments, wherein the first configuration file is one of multiple configuration files corresponding to multiple approval process, wherein each configuration file corresponds to an approval process of the multiple processes associated with an application of multiple applications.
4. The method of any one of the preceding embodiments, wherein the first configuration file includes: information related to a quantity of approval levels, wherein each approval level is associated with an approver assigned to approve or reject the first approval request.
5. The method of any one of the preceding embodiments, wherein the first approval request is caused to be approved based on receiving approval from the approver in each approval level.
6. The method of any one of the preceding embodiments, wherein the first configuration file includes information regarding the first approver.
7. The method of any one of the preceding embodiments, wherein the first configuration file includes an approver function that is configured to determine the first approver dynamically upon receipt of the first approval request.
8. The method of any one of the preceding embodiments, wherein the first approver is determined based on organization hierarchy data, seniority of an employee in an organization, role of the employee in the organization, an area of expertise of the employee, or a number of pending approval requests in a queue associated with an employee.
9. The method of any one of the preceding embodiments, wherein the first pre-authorized approval information is associated a validity period.
10. The method of any one of the preceding embodiments, wherein the first approval request is caused to be approved based on the first pre-authorized approval information being associated a validity period that has not expired.
11. The method of any one of the preceding embodiments, wherein the first condition includes a first parameter that indicates an expected value of at least one of the request parameters.
12. The method of any one of the preceding embodiments, further comprising: obtaining predicted approval score of the first approval request that is indicative of a likelihood of the approval of the first approval request.
13. The method of any one of the preceding embodiments, wherein the first approval request is caused to be approved based on the predicted approval score satisfying a threshold approval score defined in the first pre-authorized approval information.
14. The method of any one of the preceding embodiments, wherein causing the first approval request to be approved includes adjusting the threshold approval score based on a length time since the first approval request is received.
15. The method of any one of the preceding embodiments, wherein causing the first approval request to be approved includes: automatically adjusting a request parameter of the request parameters to adjust the predicted approval score; and causing the first approval request to be approved based on the adjusted predicted approval score satisfying the threshold approval score.
16. The method of any one of the preceding embodiments, further comprising: obtaining predicted approver sentiment that is indicative of a sentiment of the first approver in the approval of the first approval request.
17. The method of any one of the preceding embodiments, wherein the first approval request is caused to be approved based on the predicted approver sentiment satisfying an expected approver sentiment defined in the first pre-authorized approval information.
18. The method of any one of the preceding embodiments further comprising: updating status information of the first approval request, the status information including (a) an approval level of multiple approval levels the first approval request is at, and (b) an approval status indicating whether the first approval request is approved, rejected or pending at the corresponding approval level.
19. A tangible, non-transitory, machine-readable medium storing instructions that, when executed by a data processing apparatus, cause the data processing apparatus to perform operations comprising those of any of embodiments 1-18.
20. A system comprising: one or more processors; and memory storing instructions that, when executed by the processors, cause the processors to effectuate operations comprising those of any of embodiments 1-18.
21. A system comprising means for performing any of embodiments 1-18.

What is claimed is:

1. A system for facilitating pre-authorized approval of approval requests from multiple applications in networked computer systems using a computer architecture with an application-independent processing system, the system comprising:
cloud-based memory configured to:
store a plurality of configuration files, wherein a first configuration file of the plurality of configuration files is representative of a first approval process associated with a first application of a plurality of applications, and includes (a) a first process ID representative of the first approval process and (b) first information regarding a first approver assigned to approve or reject a first approval request corresponding to the first approval process; and
store first pre-authorized approval information associated with the first approver, wherein the first pre-authorized approval information includes (i) a first validity period indicating a first period for which the first pre-authorized approval information is valid, and (ii) a first condition for approving the first approval request, without user intervention from the first approver for approval of the first approval request upon receipt of the first approval request;
cloud-based control circuitry configured to:
receive, via an application programming interface of the processing system, the first approval request from the first application, the first approval request including the first process ID and request parameters, the request parameters including user parameters related to a user associated with the first approval request or product/service parameters related to a product/service requested in the first approval request;
determine, using the first configuration file, that the first approver is authorized to approve the first approval request, the first configuration file obtained based on the first process ID;
obtain, via a machine learning model, a score associated with the first approval request, wherein the score is indicative of a likelihood of approval of the first approval request;
retrieve the first pre-authorized approval information associated with the first approver for the first process II); and
cause the first approval request to be approved, without user intervention from the first approver for approval, based on the first pre-authorized approval information being valid, and the request parameters and the score satisfying the first condition of the first pre-authorized approval information; and
cloud-based I/O circuitry configured to:
generate for display, on a local display device, a status of the first approval request, the status indicating an approval of the first approval request.

2. A method for facilitating pre-authorized approval of approval requests in networked computer systems using a computer architecture with an application-independent processing system, the method comprising:
obtaining, via an application programming interface of a processing system, a first approval request from a first application, the first approval request including a first process ID and request parameters, the request parameters including user parameters related to a user associated with the first approval request or product/service parameters related to a product/service requested in the first approval request;
obtaining, based on the first process ID, a first configuration file that is representative of a first approval process;
determining, using the first configuration file, a first approver for approving the first approval request;
obtaining, via a machine learning model, a score associated with the first approval request, wherein the score is indicative of a likelihood of approval of the first approval request;
obtaining first pre-authorized approval information associated with the first approver for the first process ID, wherein the first pre-authorized approval information includes a first condition for approving the first approval request; and
causing the first approval request to be approved, without user intervention from the first approver upon receipt of the first approval request, based on the request parameters and the score satisfying the first condition of the first pre-authorized approval information.

3. The method of claim 2, wherein obtaining the first configuration file includes:
obtaining the first configuration file from multiple configuration files corresponding to multiple approval processes, wherein each configuration file corresponds to an approval process of the multiple processes associated with an application of multiple applications.

4. The method of claim 2, wherein the first configuration file includes:
information related to a quantity of approval levels, wherein each approval level is associated with an approver assigned to approve or reject the first approval request.

5. The method of claim 4, wherein causing the first approval request to be approved includes:
causing the first approval request to be approved based on receiving approval from the approver in each approval level.

6. The method of claim 2, wherein the first configuration file includes:
an approver function that is configured to determine the first approver.

7. The method of claim 6, wherein determining the first approver includes:
determining the first approver based on organization hierarchy data, seniority of an employee in an organization, role of the employee in the organization, or an area of expertise of the employee.

8. The method of claim 2, wherein causing the first approval request to be approved includes:
causing the first approval request to be approved based on the first pre-authorized approval information being associated a validity period that has not expired.

9. The method of claim 2, wherein causing the first approval request to be approved based on the first condition includes:
causing the first approval request to be approved based on a determination that (a) at least some of the request parameters match with a set of parameters defined in the first condition, and (b) the score matches a score range in the first condition.

10. The method of claim 2, wherein the first condition includes:
a set of parameters including (a) a first parameter that indicates an expected value of at least one of the request parameters, (b) a second parameter that indicates whether determining the first approval request satisfies the first condition is mandatory, and (c) a third parameter that indicates whether the first condition is to be checked at each approval level of multiple approval levels.

11. The method of claim 2, wherein obtaining the score further includes:
obtaining, via the machine learning model, a prediction related to a sentiment associated with approval or rejection of the first approval request.

12. The method of claim 11, wherein causing the first approval request to be approved based on the first condition includes:
causing the first approval request to be approved based on a determination that the prediction related to the sentiment matches with a sentiment defined in the first condition.

13. The method of claim 2, wherein obtaining the score includes:
training, the machine learning model, with training data to generate prediction data related to scores, wherein the training data includes multiple approval requests corresponding to the first process and information regarding whether each of the multiple approval requests is approved or rejected by the first approver.

14. The method of claim 13, further comprising:
training, the machine learning model, with the training data to generate prediction data related to sentiment of approval or rejection of the approval requests, wherein the training data includes comments on approval or rejection of each of the multiple approval requests by the first approver.

15. The method of claim 2, further comprising:
updating status information of the first approval request, wherein the status information includes (a) an approval level of multiple approval levels the first approval request is at, and (b) an approval status indicating whether the first approval request is approved, rejected or pending at the corresponding approval level.

16. A non-transitory computer-readable medium, for facilitating pre-authorized approval of approval requests in networked computer systems using a computer architecture with an application-independent processing system, comprising instructions that, when executed by one or more processors, cause operations comprising:
obtaining, via an application programming interface of a processing system, a first approval request from a first application, the first approval request including a first process ID and request parameters, the request parameters including user parameters related to a user associated with the first approval request or product/service parameters related to a product/service requested in the first approval request;
obtaining, based on the first process ID, a first configuration file that is representative of a first approval process;
determining, using the first configuration file, a first approver for approving the first approval request;
obtaining, via a machine learning model, a score associated with the first approval request, wherein the score is indicative of a likelihood of approval of the first approval request;
obtaining first pre-authorized approval information associated with the first approver for the first process ID, wherein the first pre-authorized approval information includes a first condition for approving the first approval request; and
causing the first approval request to be approved, without user intervention from the first approver upon receipt of the first approval request, based on the request parameters and the score satisfying the first condition of the first pre-authorized approval information.

17. The computer-readable medium of claim 16, wherein the first configuration file includes:
an approver function that is configured to determine the first approver, wherein the first approver is determined based on organization hierarchy data, seniority of an employee in an organization, role of the employee in the organization, or an area of expertise of the employee.

18. The computer-readable medium of claim 16, wherein causing the first approval request to be approved includes:
causing the first approval request to be approved based on (a) the first pre-authorized approval information being associated a validity period that has not expired, (b) at least some of the request parameters matching a set of parameters defined in the first condition, and (b) the score matching a score range in the first condition.

19. The computer-readable medium of claim 16, wherein the first condition includes:
a first parameter that indicates whether determining the first approval request satisfies the first condition is mandatory, and a second parameter that indicates whether the first condition is to be checked at each approval level of multiple approval levels.

20. The computer-readable medium of claim 16, further comprising:
updating status information of the first approval request, wherein the status information includes (a) an approval level of multiple approval levels the first approval request is at, and (b) an approval status indicating whether the first approval request is approved, rejected or pending at the corresponding approval level.
